(19) United States
(12) Patent Application Publication
(10) Pub. No.: US 2021/0004748 A1
(43) Pub. Date: Jan. 7, 2021

(54) EMPLOYEES COLLABORATION STRENGTH

(71) Applicant: Microsoft Technology Licensing, LLC, Redmond, WA (US)

(72) Inventors: Rajath Kumar Ravi, Hyderabad (IN); Rishabh Agrawal, Hyderabad (IN)

(21) Appl. No.: 16/460,235

(22) Filed: Jul. 2, 2019

(51) Int. Cl. G06Q 10/06; G06Q 10/10

(52) U.S. Cl. CPC G06Q 10/06393; G06Q 10/103

(57) ABSTRACT

A system and method for determining collaboration strength among users in an enterprise is described. The system identifies a plurality of users of an enterprise. The system accesses user interaction data from one or more applications operating within the enterprise. The user interaction data indicate interactions among the plurality of users using the one or more applications. The system computes collaboration metrics for a user of the plurality of users based on the user interaction data, computes a collaboration strength score based the collaboration metrics for the user, and provides the collaboration strength score to a client device of the user.

### BACKGROUND

The subject matter disclosed herein generally relates to a special-purpose machine that analyzes communications between client devices, including computerized variants of such special-purpose machines and improvements to such variants. Specifically, the present disclosure addresses systems and methods for computing a collaboration strength score based on interactions between employees of an enterprise.

Social networks provide a platform for users to socially interact with one another. However, social interaction within an enterprise setting may be difficult to be evaluated given the noise of the interaction data between employees.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a diagrammatic representation of interactions between users in an enterprise, in accordance with some example embodiments.

FIG. 3 is a block diagram illustrating a server collaboration engine in accordance with one example embodiment.

FIG. 4 is a block diagram illustrating a collaboration strength computation module in accordance with one example embodiment.

FIG. 5 is a block diagram illustrating a recommendation engine in accordance with one example embodiment.

FIG. 6 is a flow diagram illustrating a method for computing collaboration strength metrics in accordance with one example embodiment.

FIG. 7 is a flow diagram illustrating a method for providing a recommendation in accordance with one example embodiment.

FIG. 8 is a flow diagram illustrating a method for calling an application function in accordance with one example embodiment.

FIG. 9 illustrates a routine in accordance with one embodiment.

FIG. 10 illustrates an example of a graphical user interface of a collaboration strength score presentation in accordance with one example embodiment.

FIG. 11 illustrates an example of a graphical user interface of recommendations in accordance with one example embodiment.

FIG. 12 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a method for providing a Social network analysis (SNA) to enterprise users. In particular, the SNA provides a tool for understanding the behavior of networks and graphs of the users. These algorithms use graph theory to calculate the importance of any given node in a social network. The enterprise may operate several applications used by the users. The users interact with each other daily using various communication mediums and applications. This information can be used to create a graph with users as vertices and their collaborations as edges. The edges can be weighted based on how often the two users collaborate. This graph can be used to score a collaboration strength of a user in the enterprise.

The present application describes a system for determining collaboration strength among users in an enterprise. The enterprise collects enterprise collaboration data (also referred to as user interaction data). The enterprise collaboration data may include data from the email applications, instant message (IM) applications, meeting applications, calendar applications, document sharing applications, and other collaboration data. The system calculates the collaboration strength score of a user based on the enterprise collaboration data and presents the collaboration strength score to the user. In another example embodiment, the system provides a dashboard that gives the user a measure of his/her collaboration network strength and recommendations about how to increase his/her collaboration strength score.

The present application describes a system and method for determining collaboration strength among users in an enterprise is described. In one example embodiment, the system identifies a plurality of users of an enterprise. The system accesses user interaction data from one or more applications operating within the enterprise. The user interaction data indicate interactions among the plurality of users using the one or more applications. The system computes collaboration metrics for a user of the plurality of users based on the user interaction data, computes a collaboration strength score based the collaboration metrics for the user, and provides the collaboration strength score to a client device of the user.

As a result, one or more of the methodologies described herein facilitate solving the technical problem of computing a collaboration strength score of a user and generating suggested application functions based on the collaboration strength score of the user. As such, one or more of the methodologies described herein may obviate a need for certain efforts or computing resources. Examples of such computing resources include processor cycles, network traffic, memory usage, data storage capacity, power consumption, network bandwidth, and cooling capacity.

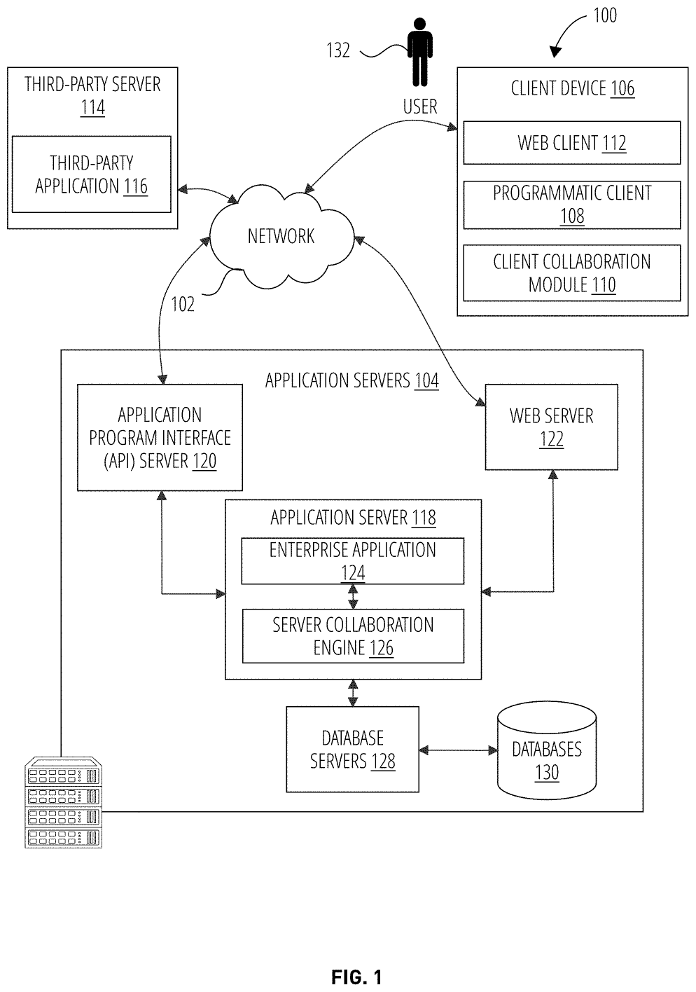

FIG. 1 is a diagrammatic representation of a network environment in which some example embodiments of the present disclosure may be implemented or deployed. One or more application servers 104 provide server-side functionality via a network 102 to a networked user device, in the form of a client device 106. A user 132 operates the client device 106. The client device 106 includes a web client 112 (e.g., a browser), a programmatic client 108 (e.g., an email/calendar application such as Microsoft Outlook™, an instant message application such as Microsoft Teams™ or Microsoft Skype™, a document writing application such as Microsoft Word™, a shared document storage application such as Microsoft One Drive™ that is hosted and executed on the client device 106. In one example embodiment, the programmatic client 108 includes a client collaboration module 110 that accesses interaction data from the web client 112 and the programmatic client 108. The interaction data identifies items that are communicated from another user of an enterprise to the user 132 and from the user 132 to another user of the enterprise. Examples of interaction data includes and are not limited to email communications, meeting communications, instant messages, shared document comments, and any communication with a recipient (e.g., a user from the enterprise).

The client collaboration module 110 may operate with the web client 112 and/or the programmatic client 108. In another example embodiment, the client collaboration module 110 is part of the programmatic client 108 or web client 112. For example, the client collaboration module 110 may operate as an extension or add on to the web client 112. The client collaboration module 110 communicates with the application servers 104.

An Application Program Interface (API) server 120 and a web server 122 provide respective programmatic and web interfaces to application servers 104. A specific application server 118 hosts an enterprise application 124 and a server collaboration engine 126. Both enterprise application 124 and server collaboration engine 126 include components, modules and/or applications.

The enterprise application 124 may include collaborative applications (e.g., a server-side email/calendar enterprise application, a server-side instant message enterprise application, a document writing enterprise application, a shared document storage enterprise application) that enable users of an enterprise to collaborate and share document, messages, and other data (e.g., meeting information, common projects) with each other. For example, the user 132 at the client device 106 may access the enterprise application 124 to edit documents that are shared with other users of the same enterprise. In another example, the client device 106 accesses the enterprise application 124 to retrieve or send messages or emails to and from other peer users of the enterprise. Other examples of enterprise application 124 includes enterprise systems, content management systems, and knowledge management systems.

In one example embodiment, the server collaboration engine 126 communicates with the enterprise application 124 to access interaction data from users of the enterprise application 124. In another example embodiment, the server collaboration engine 126 communicates with the client collaboration module 110 to access interaction data from the user 132 with other users of the enterprise. The server collaboration engine 126 communicates with the client collaboration module 110 supported by the web server 122 to identify interaction data to/from the programmatic client 108. In one example, the web client 112 communicate with the server collaboration engine 126 and enterprise application 124 via the programmatic interface provided by the Application Program Interface (API) server 120.

The server collaboration engine 126 computes a collaboration strength score based on the interaction data related to the user 132. The server collaboration engine 126 generates a recommendation based on the collaboration strength score and provides the collaboration strength score along with the collaboration strength score to the client device 106. In another example embodiment, the server collaboration engine 126 detects a selection of a recommended action from the recommendation and generates a dialog box pre-populated with information based on the recommended action (e.g., pre-filled email content addressed to select recipients—the user 132 only has to click on a send button; the user does not need to open a new email message, type in a content, and click send) for a corresponding application (e.g., email application, instant message application, shared document application).

The application server 118 is shown to be communicatively coupled to database servers 128 that facilitates access to an information storage repository or databases 130. In an example embodiment, the databases 130 includes storage devices that store information to be processed by the enterprise application 124 and the server collaboration engine 126.

Additionally, a third-party application 116 may, for example, store another part of the enterprise application 124, or include a cloud storage system. The third-party application 116 executing on a third-party server 114, is shown as having programmatic access to the application server 118 via the programmatic interface provided by the Application Program Interface (API) server 120. For example, the third-party application 116, using information retrieved from the application server 118, may supports one or more features or functions on a website hosted by the third party.

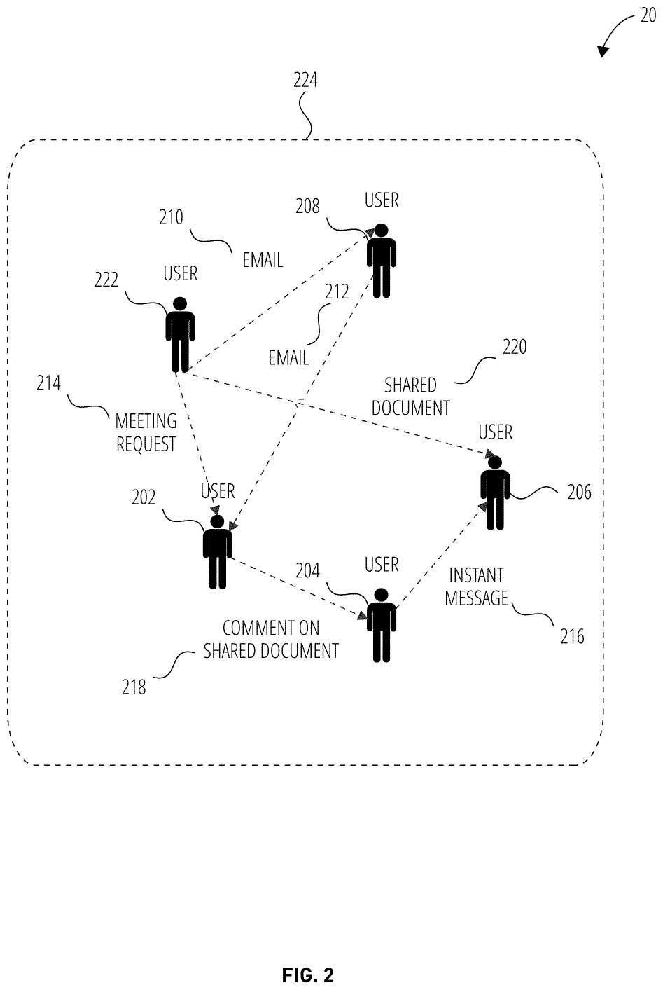

FIG. 2 is a diagrammatic representation of interactions between users in an enterprise, in accordance with some example embodiments. The diagram illustrates peer users (e.g., user 202, user 206, user 208, user 222) that are part of an enterprise 224. The peer users use a respective client device (not shown) using one or more client applications (not shown) to communicate and collaborate with one another.

For example, user 222 sends an email 210 to user 208, sends a shared document 220 to user 206, and sends a meeting request 214 to user 202. The user 208 receives the email 210 from user 222, sends an email 212 to user 202. The user 202 receives the meeting request 214 from user 222, receives the email 212 from user 208, and share a comment on shared document 218 with user 204. The user 204 receives the comment on shared document 218 from 202 and sends an instant message 216 to user 206.

In one example embodiment, the server collaboration engine 126 collects user interaction data representing the interactions between peer users described above. In another example embodiment, the client collaboration module 110 collects interaction data from a corresponding user of a client device. The server collaboration engine 126 and the client collaboration module 110 may collect the interaction data for a preset period (e.g., a one-week interval, year to date, or other time frame).

In another example embodiment, the server collaboration engine 126 collects user interaction data for a user up to a preset degree of contacts. For example, if the preset degree is one, the interaction data for the user 222 includes interaction data for user 208, user 202, and user 206. A core working group of the user 222 would thus include user 208, user 202, and user 206.

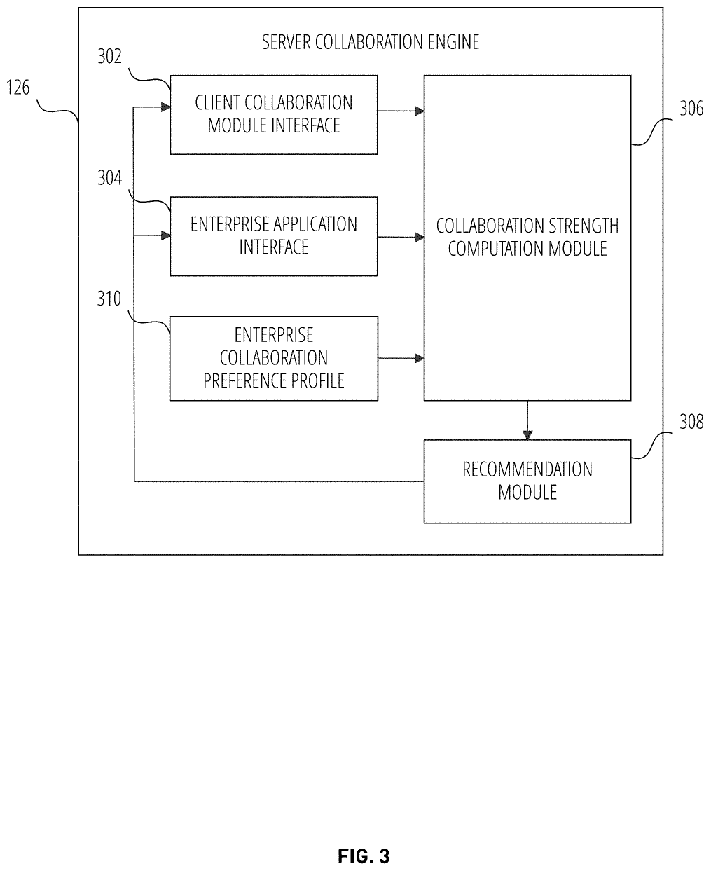

FIG. 3 is a block diagram illustrating a server collaboration engine in accordance with one example embodiment. The server collaboration engine 126 comprises a client collaboration module interface 302, an enterprise application interface 304, a collaboration strength computation module 306, a recommendation module 308, and an enterprise collaboration preference profile 310.

The client collaboration module interface 302 communicates with the client devices of the users in the enterprise. In one example embodiment, the client collaboration module interface 302 retrieves user interaction data from the client collaboration module 110 of client device 106. In another example embodiment, the client collaboration module interface 302 accesses user interaction data from the web client 112 or the programmatic client 108.

The enterprise application interface 304 communicates with the enterprise application 124. In one example embodiment, the enterprise application interface 304 retrieves user interaction data from the enterprise application 124.

The enterprise collaboration preference profile 310 retrieves a collaboration profile for the enterprise, for a specific group of the enterprise, or for a specific user of the enterprise. The collaboration profile indicates a minimum collaboration threshold score for the enterprise, a group in the enterprise, or a user of the enterprise. In another example embodiment, the collaboration profile indicates multiple classes of user collaboration levels and may not be based on preset thresholds. The server collaboration engine 126 identifies users fitting in a particular class (with a lower collaboration strength score). In another example embodiment, the server collaboration engine 126 identifies users fitting in a particular class (with a higher collaboration strength score).

The collaboration strength computation module 306 computes a collaboration strength score for each user of the enterprise based on the user interaction data from client collaboration module interface 302 and enterprise application interface 304. In one example embodiment, the collaboration strength computation module 306 calculates scores for various actions (for a collaboration between two users) depending on their importance/priority (which represents the edge weight between the 2 users in the collaboration). For example, the collaboration strength computation module 306 assigns a weight to a specific interaction:

Email Sent=1

Email Received=1

Email Replied (as a result of an initial email)=2

Email Sending as a reply=2

Meeting Invite Sent & Accepted=2

Meeting Invite Sent & Not answered or Tentative=1

Meeting Invite Received & Accepted=2

Skype For Business Chat=0.5

Instant Message (MS Teams) 1:1 Chat=0.5

Instant Message (MS Teams) Channel Chat=0.25

One Drive/SharePoint Comment=0.5

One Drive/SharePoint Reply to a Comment=1

Any communication with @[Name]=1

The collaboration strength computation module 306 computes metrics based on the weight assigned to each type of interaction based on the user interaction data between users of the enterprise. In another example embodiment, the collaboration strength computation module 306 computes metrics based on the weight assigned to each type of interaction based on the user interaction data for a user. In another example embodiment, the collaboration strength computation module 306 computes metrics based on the weight assigned to each type of interaction based on the user interaction data between a user and other users up to a preset number of degrees.

In one example embodiment, the collaboration strength computation module 306 calculates different metrics based on the user interaction data and the preset weights. For example, the collaboration strength computation module 306 computes a degree centrality metric, an eigen centrality metric, a betweenness centrality metric, and a closeness centrality metric. The degree centrality metric measures how well a user is connected in his/her core working group. The eigen centrality metric measures how well peers of the user in his/her core working group are connected. The betweenness centrality metric measures how well a user influences the flow around his/her core working group and how well the user can act as a bridge to connect two other users. The closeness centrality metric measures how close the user is to his/her core working group and how well the user can influence his/her entire enterprise social network. In another example embodiment, the collaboration strength computation module 306 computes a collaboration strength score based on the above calculated metrics. For example, the collaboration strength computation module 306 computes the collaboration strength score based on an average or mean of the calculated metrics.

The recommendation module 308 classifies a user based on his/her collaboration strength score (and/or the different metrics). For example, the recommendation module 308 classifies a user into one of five categories: Excellent, Above Average, Acceptable, Needs Improvement, and Poor.

In another example embodiment, the recommendation module 308 compares the different metrics and/or the collaboration strength score with a preset threshold (for the user, the group, or the enterprise) and generates a recommendation based on comparison. For example, if the collaboration strength score of the user 132 is below a preset collaboration strength score threshold, the recommendation module 308 provides one or more recommendations on how to improve the preset collaboration strength score threshold. For example, the recommendation module 308 may suggest that the user read unread emails, responds to an instant message, or review a document shared with the user. The recommendation module 308 generates a function call to an application corresponding to the suggestion selected by the user. For example, if the user selects the read unread emails, the recommendation module 308 launches the email application at the client device of the user to show the unread emails.

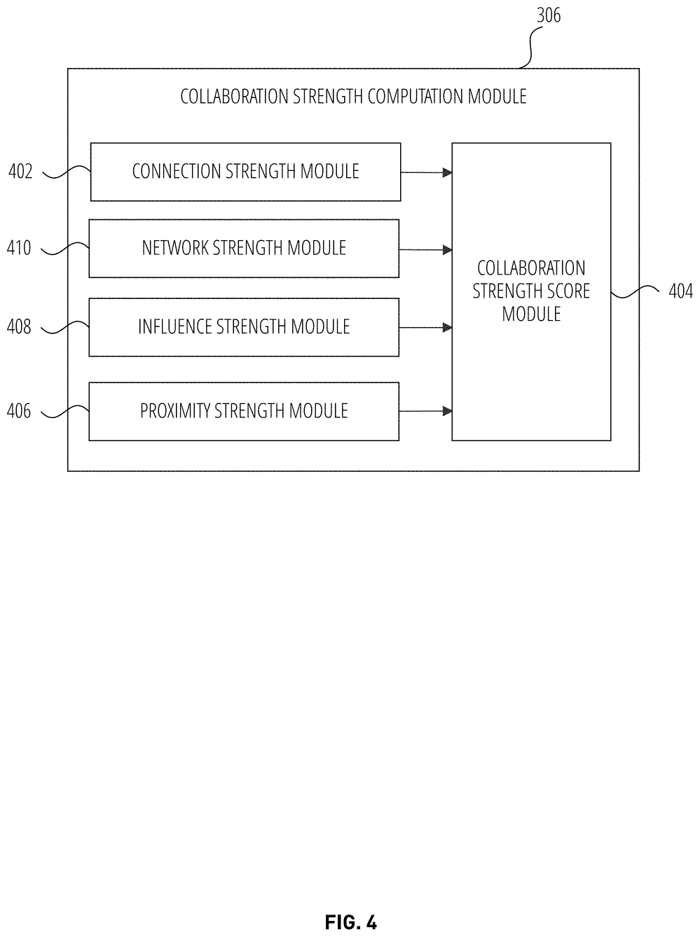

FIG. 4 is a block diagram illustrating a collaboration strength computation module in accordance with one example embodiment. The collaboration strength computation module 306 computes different metrics using a connection strength module 402, a proximity strength module 406, an influence strength module 408, a network strength module 410, and a collaboration strength score module 404. The connection strength module 402 computes the degree centrality metric. The network strength module 410 computes the eigen centrality metric. The influence strength module 408 computes the betweenness centrality metric. The proximity strength module 406 computes the closeness centrality metric. The collaboration strength score module 404 uses the computed metrics from connection strength module 402, network strength module 410, influence strength module 408, and proximity strength module 406 to calculate the collaboration strength score.

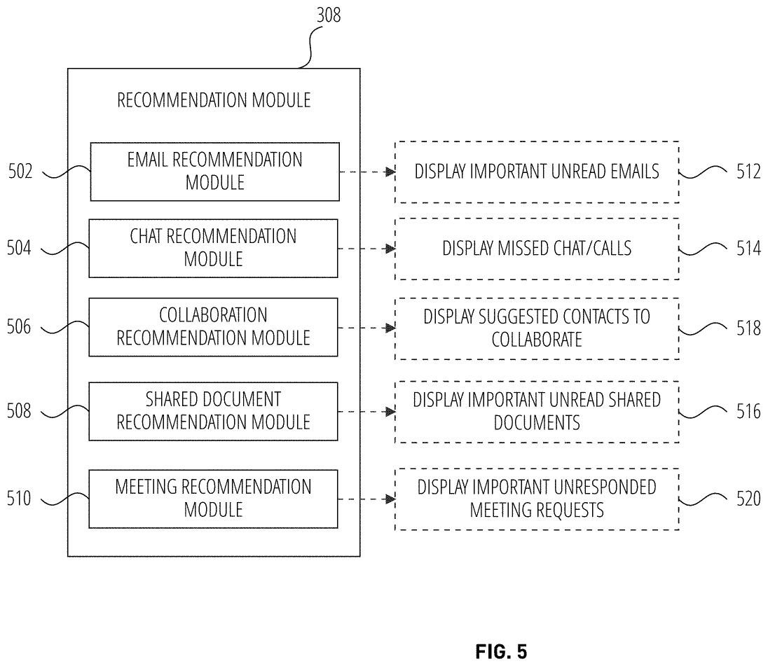

FIG. 5 is a block diagram illustrating a recommendation engine in accordance with one example embodiment. The recommendation module 308 comprises an email recommendation module 502, a chat recommendation module 504, a collaboration recommendation module 506, a shared document recommendation module 508, and a meeting recommendation module 510. The following is an example of different functions of different enterprise applications by the corresponding modules: the email recommendation module 502 generates a display of unread emails from important users 512 and launches the email application showing the unread emails. The chat recommendation module 504 generates a display of missed chat/calls from select recipients 514 and launches the corresponding communication tool. The collaboration recommendation module 506 displays suggested contacts (e.g., select recipients 518) to collaborate with and launches the corresponding communication tool. The shared document recommendation module 508 displays important unread shared documents (e.g., shared documents 516) and launches the document sharing application to display the unread shared documents. The meeting recommendation module 510 generates a display of important un-responded meeting requests and launches a meeting response for select meeting requests 520.

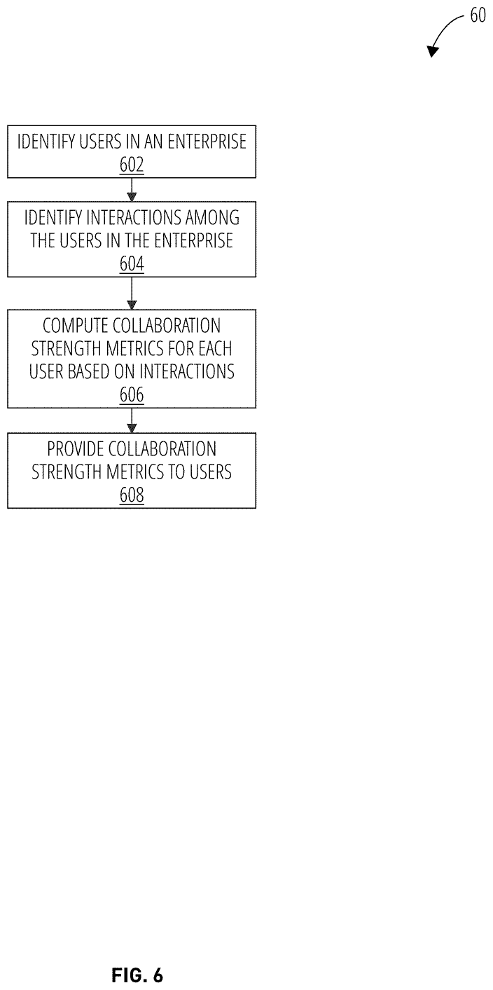

FIG. 6 is a flow diagram illustrating a method 600 for computing collaboration strength metrics in accordance with one example embodiment. Operations in the method 600 may be performed by the server collaboration engine 126, using components (e.g., modules, engines) described above with respect to FIG. 3. Accordingly, the method 600 is described by way of example with reference to the server collaboration engine 126. However, it shall be appreciated that at least some of the operations of the method 600 may be deployed on various other hardware configurations or be performed by similar components residing elsewhere. For example, some of the operations may be performed at the client collaboration module 110.

At block 602, the server collaboration engine 126 identifies users in an enterprise (e.g., enterprise 224). At block 604, the server collaboration engine 126 identifies interactions among the users in the enterprise 224. At block 606, the server collaboration engine 126 computes collaboration strength metrics for each user based on user interactions. At block 608, the server collaboration engine 126 provides the collaboration strength metrics to the users (or to a user of the enterprise).

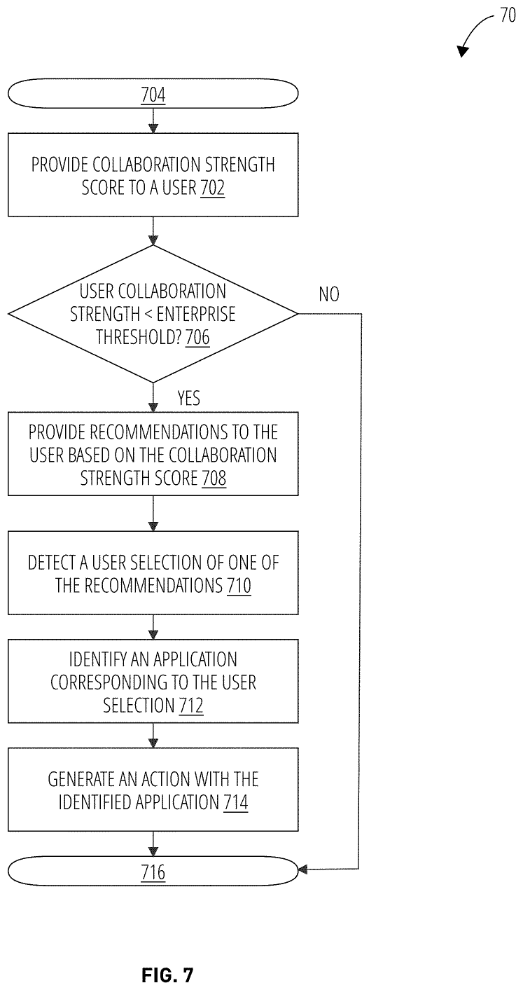

FIG. 7 is a flow diagram illustrating a method 700 for providing a recommendation in accordance with one example embodiment. Operations in the method 700 may be performed by the server collaboration engine 126, using components (e.g., modules, engines) described above with respect to FIG. 3. Accordingly, the method 700 is described by way of example with reference to the server collaboration engine 126. However, it shall be appreciated that at least some of the operations of the method 700 may be deployed on various other hardware configurations or be performed by similar components residing elsewhere. For example, some of the operations may be performed at the client collaboration module 110.

At block 702, the server collaboration engine 126 provides a collaboration strength score to a user of the enterprise. At decision block 706, the server collaboration engine 126 determines whether the user collaboration strength is less than a preset minimum enterprise collaboration threshold. If yes, at block 708, the server collaboration engine 126 provides recommendations to the user based on the collaboration strength score of the user. At block 710, the server collaboration engine 126 detects a user's selection of one of the recommendations (e.g., the user clicks on one of the recommendations). At block 712, the server collaboration engine 126 identifies the application corresponding to the user's selection. At block 714, the server collaboration engine 126 generates an action (e.g., call a specific function of an application with predefined data from the interaction data) with the identified application. The method 700 starts at done block 704 and ends at done block 716. In another example, once the action from block 714 is completed, the collaboration strength metrics are again computed at block 606.

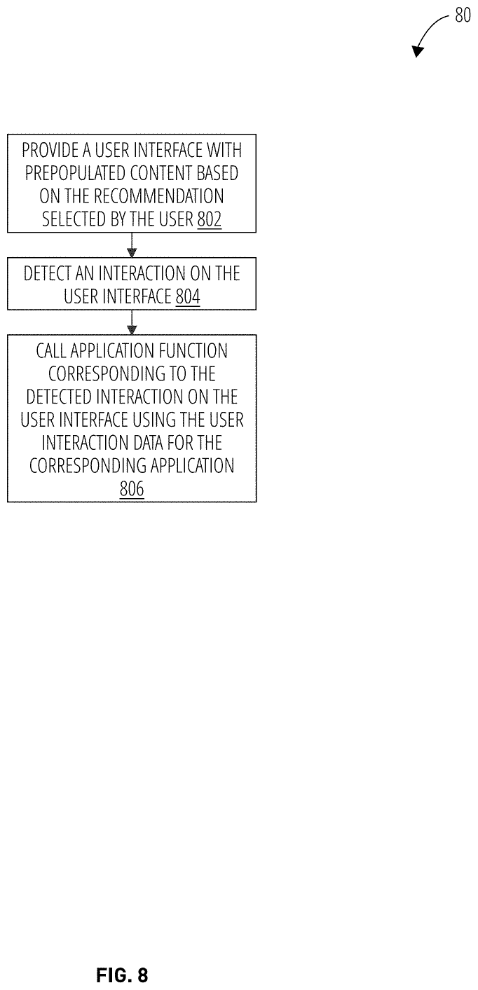

FIG. 8 is a flow diagram illustrating a method 800 for calling an application function in accordance with one example embodiment. Operations in the method 800 may be performed by the server collaboration engine 126, using components (e.g., modules, engines) described above with respect to FIG. 3. Accordingly, the method 800 is described by way of example with reference to the server collaboration engine 126. However, it shall be appreciated that at least some of the operations of the method 800 may be deployed on various other hardware configurations or be performed by similar components residing elsewhere. For example, some of the operations may be performed at the client collaboration module 110, programmatic client 108, or web client 112.

At block 802, the server collaboration engine 126 provides a user interface with prepopulated content based on the recommendation selected by the user. At block 804, the server collaboration engine 126 detects an interaction on the user interface. At block 806, the server collaboration engine 126 calls for an application function corresponding to the detected interaction on the user interface using the user interaction data for the corresponding application (e.g., email messages with preselected recipients and prepopulated messages with relevant content related to common projects).

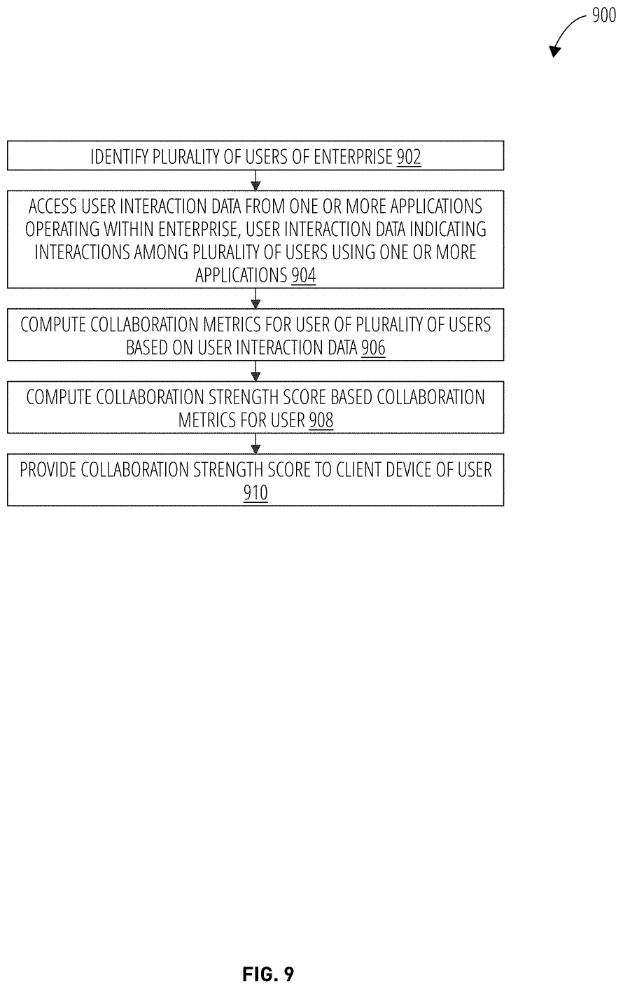

FIG. 9 illustrates a routine in accordance with one embodiment. In block 902, routine 900 identifies a plurality of users of an enterprise. In block 904, routine 900 accesses user interaction data from one or more applications operating within the enterprise, the user interaction data indicating interactions among the plurality of users using the one or more applications. In block 906, routine 900 computes collaboration metrics for a user of the plurality of users based on the user interaction data. In block 908, routine 900 computes a collaboration strength score based the collaboration metrics for the user. In block 910, routine 900 provides the collaboration strength score to a client device of the user.

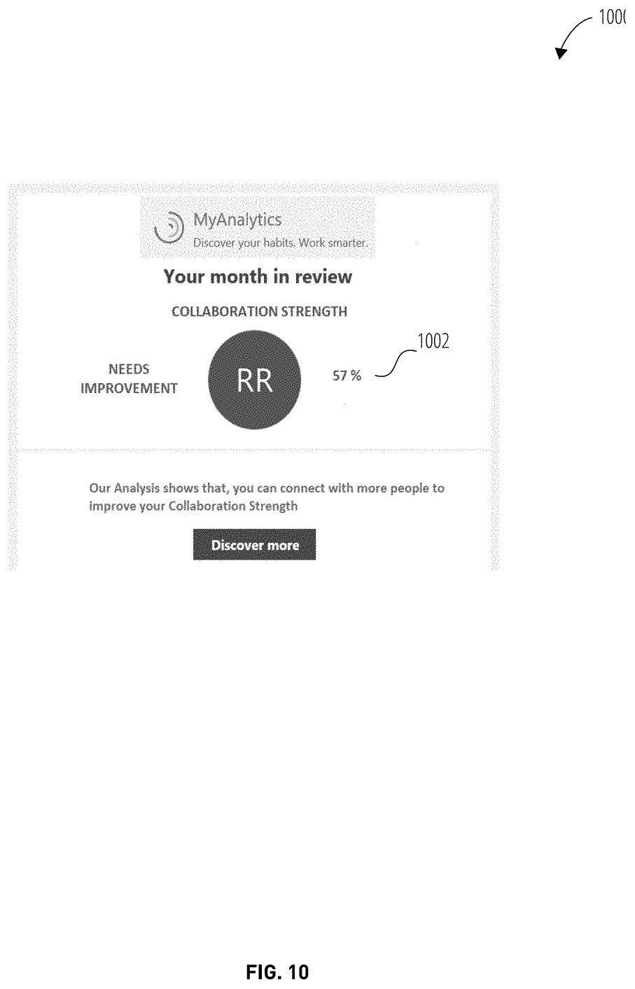

FIG. 10 illustrates an example of a graphical user interface 1000 of a collaboration strength score presentation in accordance with one example embodiment. The graphical user interface 1000 indicates a collaboration strength score 1002.

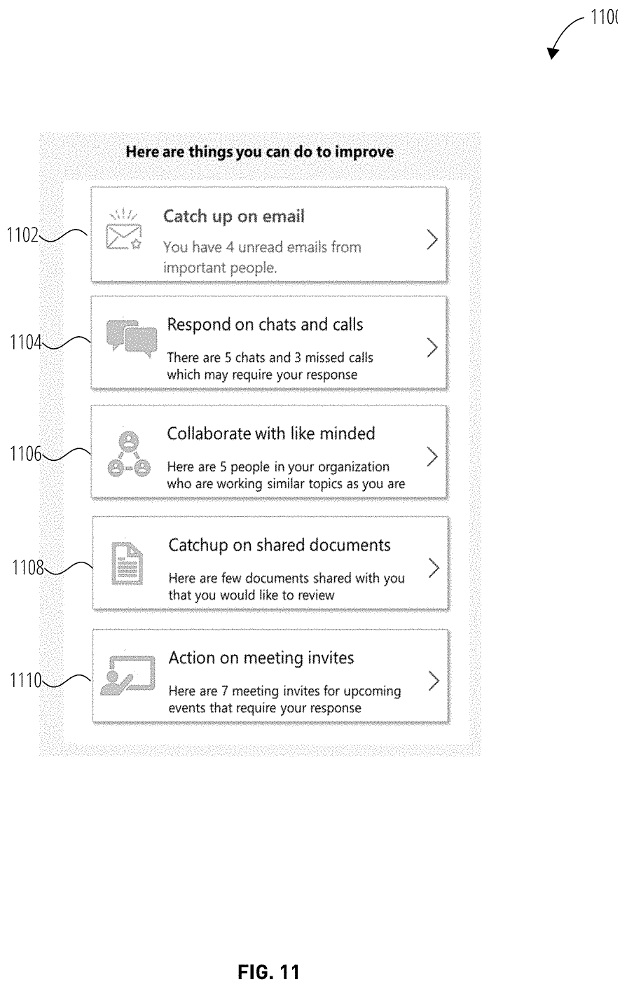

FIG. 11 illustrates an example of a graphical user interface 1100 of recommendations in accordance with one example embodiment. The graphical user interface 1100 includes an email recommendation 1102, a chat recommendation 1104, a collaboration recommendation 1106, a shared document recommendation 1108, a meeting recommendation 1110. When the user clicks on a recommendation, an application corresponding to the recommendation is launched. For example, when the user clicks on the meeting recommendation 1110, a meeting response for the meeting invites in the calendar application is launched. With a single-click, the user can contribute to his enterprise collaboration strength score 1002.

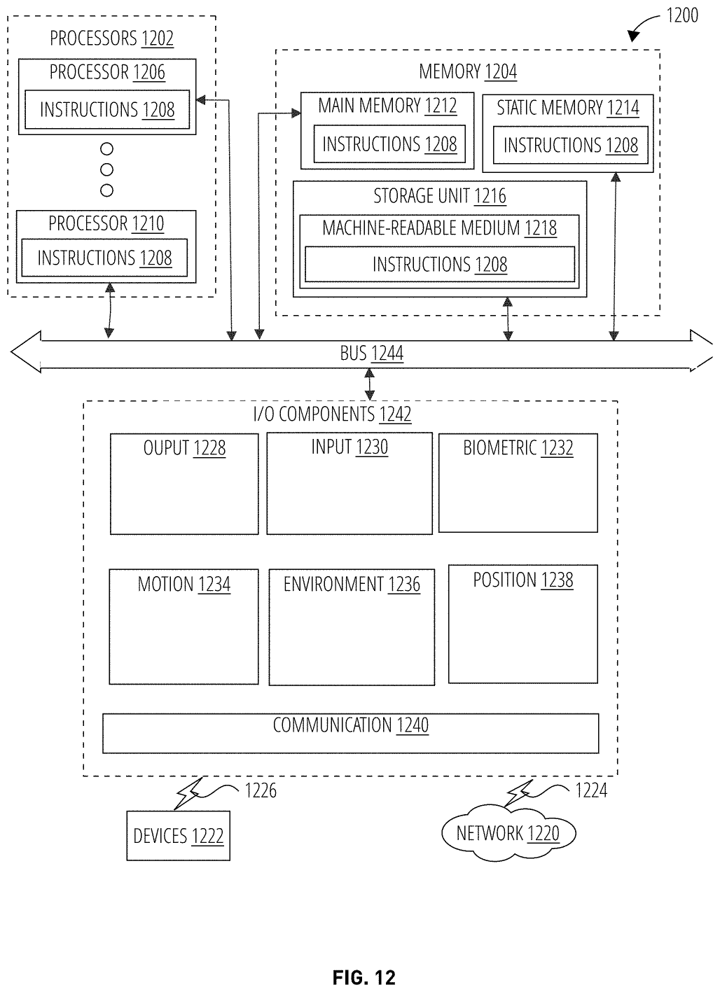

FIG. 12 is a diagrammatic representation of the machine 1200 within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute any one or more of the methods described herein. The instructions 1208 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines that individually or jointly execute the instructions 1208 to perform any one or more of the methodologies discussed herein.

The machine 1200 may include processors 1202, memory 1204, and I/O components 1242, which may be configured to communicate with each other via a bus 1244. In an example embodiment, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1206 and a processor 1210 that execute the instructions 1208. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 includes a main memory 1212, a static memory 1214, and a storage unit 1216, both accessible to the processors 1202 via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the processors 1202 (e.g., within the processor's cache memory), or any suitable combination thereof, during execution thereof by the machine 1200.

The I/O components 1242 may include a wide variety of components to receive input, provide output, produce output, transmit information, exchange information, capture measurements, and so on. The specific I/O components 1242 that are included in a particular machine will depend on the type of machine. For example, portable machines such as mobile phones may include a touch input device or other such input mechanisms, while a headless server machine will likely not include such a touch input device. It will be appreciated that the I/O components 1242 may include many other components that are not shown in FIG. 12. In various example embodiments, the I/O components 1242 may include output components 1228 and input components 1230. The output components 1228 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1230 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1242 may include biometric components 1232, motion components 1234, environmental components 1236, or position components 1238, among a wide array of other components. For example, the biometric components 1232 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 include acceleration sensor components (e.g., accelerometer), gravitation sensor components, rotation sensor components (e.g., gyroscope), and so forth. The environmental components 1236 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1242 further include communication components 1240 operable to couple the machine 1200 to a network 1220 or devices 1222 via a coupling 1224 and a coupling 1226, respectively. For example, the communication components 1240 may include a network interface component or another suitable device to interface with the network 1220. In further examples, the communication components 1240 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1222 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, location via detecting an NFC beacon signal that may indicate a particular location, and so forth.

The various memories (e.g., memory 1204, main memory 1212, static memory 1214, and/or memory of the processors 1202) and/or storage unit 1216 may store one or more sets of instructions and data structures (e.g., software) embodying or used by any one or more of the methodologies or functions described herein. These instructions (e.g., the instructions 1208), when executed by processors 1202, cause various operations to implement the disclosed embodiments.

The instructions 1208 may be transmitted or received over the network 1220, using a transmission medium, via a network interface device (e.g., a network interface component included in the communication components 1240) and using any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### Examples

Example 1 is a computer-implemented method comprising: identifying a plurality of users of an enterprise; accessing user interaction data from one or more applications operating within the enterprise, the user interaction data indicating interactions among the plurality of users using the one or more applications; computing collaboration metrics for a user of the plurality of users based on the user interaction data; computing a collaboration strength score based the collaboration metrics for the user; and providing the collaboration strength score to a client device of the user.

Example 2 is a computer-implemented method of example 1, wherein computing the collaboration metrics further comprise: accessing interactions within the enterprise for the user up to a predefined degree of contacts; forming a core working group of the user based on the accessed interactions; and calculating the collaboration metrics based on the core working group of the user.

Example 3 is a computer-implemented method of example 1, wherein computing the collaboration metrics further comprise: identifying a weight corresponding to an action of a corresponding application, the action being directed to the user from another user within the enterprise or from the user to another user within the enterprise; determining a number of actions for each application; applying the weight of the corresponding action to the number of actions for each application; and computing a total score based on the applied weight of the corresponding action to the number of actions for each application.

Example 4 is a computer-implemented method of example 3, wherein the collaboration metrics comprise a degree centrality metric, an eigen centrality metric, a betweenness centrality metric, and a closeness centrality metric.

Example 5 is a computer-implemented method of example 4, wherein the degree centrality metric indicates a connection strength, the eigen centrality metric indicates a network strength, the betweenness centrality metric indicates an influence strength, and the closeness centrality metric indicates a proximity strength.

Example 6 is a computer-implemented method of example 6, further comprising: determining a collaboration category of the user based on the collaboration strength score of the user; and providing the collaboration category of the user to the client device of the user.

Example 7 is a computer-implemented method of example 1, further comprising: determining that the collaboration strength score of the user is below a preset collaboration threshold for the enterprise; and generating a recommendation to the user in response to determining that the collaboration strength score of the user is below a preset collaboration threshold of the enterprise, the recommendation comprising at least one recommended action for the user in using the one or more applications operating within the enterprise.

Example 8 is a computer-implemented method of example 7, further comprising: detecting, from the client device of the user, a selected recommended action from the recommendation; identifying an application from the one or more applications, the identified application corresponding to the selected recommended action; and calling an application function of the identified application on the client device of the user.

Example 9 is a computer-implemented method of example 8, wherein the application function generates a prepopulated message to one or more users identified from the selected recommendation.

Example 10 is a computer-implemented method of example 1, wherein the one or more applications comprise at least one of an email application, an instant message application, a document sharing application, a meeting application, and a calendar application.

What is claimed is:

1. A computer-implemented method comprising:
identifying a plurality of users of an enterprise;
accessing user interaction data from one or more applications operating within the enterprise, the user interaction data indicating interactions among the plurality of users using the one or more applications;
computing collaboration metrics for a user of the plurality of users based on the user interaction data;
computing a collaboration strength score based the collaboration metrics for the user; and
providing the collaboration strength score to a client device of the user.

2. The computer-implemented method of claim 1, wherein computing the collaboration metrics further comprise:
accessing interactions within the enterprise for the user up to a predefined degree of contacts;
forming a core working group of the user based on the accessed interactions; and
calculating the collaboration metrics based on the core working group of the user.

3. The computer-implemented method of claim 1, wherein computing the collaboration metrics further comprise:
identifying a weight corresponding to an action of a corresponding application, the action being directed to the user from another user within the enterprise or from the user to another user within the enterprise;
determining a number of actions for each application;
applying the weight of the corresponding action to the number of actions for each application; and
computing a total score based on the applied weight of the corresponding action to the number of actions for each application.

4. The computer-implemented method of claim 3, further wherein the collaboration metrics comprise a degree centrality metric, an eigen centrality metric, a betweenness centrality metric, and a closeness centrality metric.

5. The computer-implemented method of claim 4, wherein the degree centrality metric indicates a connection strength, the eigen centrality metric indicates a network strength, the betweenness centrality metric indicates an influence strength, and the closeness centrality metric indicates a proximity strength.

6. The computer-implemented method of claim 1, further comprising:
determining a collaboration category of the user based on the collaboration strength score of the user; and
providing the collaboration category of the user to the client device of the user.

7. The computer-implemented method of claim 1, further comprising:
determining that the collaboration strength score of the user is below a preset collaboration threshold for the enterprise; and
generating a recommendation to the user in response to determining that the collaboration strength score of the user is below a preset collaboration threshold of the enterprise, the recommendation comprising at least one recommended action for the user in using the one or more applications operating within the enterprise.

8. The computer-implemented method of claim 7, further comprising:
detecting, from the client device of the user, a selected recommended action from the recommendation;
identifying an application from the one or more applications, the identified application corresponding to the selected recommended action; and
calling an application function of the identified application on the client device of the user.

9. The computer-implemented method of claim 8, wherein the application function generates a prepopulated message to one or more users identified from the selected recommendation.

10. The computer-implemented method of claim 1, wherein the one or more applications comprise at least one of an email application, an instant message application, a document sharing application, a meeting application, and a calendar application.

11. A computing apparatus, the computing apparatus comprising:
a processor; and
a memory storing instructions that, when executed by the processor, configure the apparatus to:
identify a plurality of users of an enterprise;
access user interaction data from one or more applications operating within the enterprise, the user interaction data indicating interactions among the plurality of users using the one or more applications;
compute collaboration metrics for a user of the plurality of users based on the user interaction data;
compute a collaboration strength score based the collaboration metrics for the user; and
provide the collaboration strength score to a client device of the user.

12. The computing apparatus of claim 11, wherein computing the collaboration metrics further comprise:
access interactions within the enterprise for the user up to a predefined degree of contacts;
form a core working group of the user based on the accessed interactions; and
calculate the collaboration metrics based on the core working group of the user.

13. The computing apparatus of claim 11, wherein computing the collaboration metrics further comprise:
identify a weight corresponding to an action of a corresponding application, the action being directed to the user from another user within the enterprise or from the user to another user within the enterprise;
determine a number of actions for each application;
apply the weight of the corresponding action to the number of actions for each application; and
compute a total score based on the applied weight of the corresponding action to the number of actions for each application.

14. The computing apparatus of claim 13, further wherein the collaboration metrics comprise a degree centrality metric, an eigen centrality metric, a betweenness centrality metric, and a closeness centrality metric.

15. The computing apparatus of claim 14, wherein the degree centrality metric indicates a connection strength, the eigen centrality metric indicates a network strength, the betweenness centrality metric indicates an influence strength, and the closeness centrality metric indicates a proximity strength.

16. The computing apparatus of claim 11, wherein the instructions further configure the apparatus to:
determine a collaboration category of the user based on the collaboration strength score of the user; and
provide the collaboration category of the user to the client device of the user.

17. The computing apparatus of claim 11, wherein the instructions further configure the apparatus to:
determine that the collaboration strength score of the user is below a preset collaboration threshold for the enterprise; and
generate a recommendation to the user in response to determining that the collaboration strength score of the user is below a preset collaboration threshold of the enterprise, the recommendation comprising at least one recommended action for the user in using the one or more applications operating within the enterprise.

18. The computing apparatus of claim 17, wherein the instructions further configure the apparatus to:
detect, from the client device of the user, a selected recommended action from the recommendation;
identify an application from the one or more applications, the identified application corresponding to the selected recommended action; and
call an application function of the identified application on the client device of the user.

19. The computing apparatus of claim 18, wherein the application function generates a prepopulated message to one or more users identified from the selected recommendation.

20. A non-transitory computer-readable storage medium, the computer-readable storage medium including instructions that when executed by a computer, cause the computer to:
identify a plurality of users of an enterprise;
access user interaction data from one or more applications operating within the enterprise, the user interaction data indicating interactions among the plurality of users using the one or more applications;
compute collaboration metrics for a user of the plurality of users based on the user interaction data;
compute a collaboration strength score based the collaboration metrics for the user; and
provide the collaboration strength score to a client device of the user.
